(19) United States
(12) Patent Application Publication
(10) Pub. No.: US 2017/0273415 A1
(43) Pub. Date: Sep. 28, 2017

(54) Systems and Methods for Wearable Technology with Creative Expression

(71) Applicant: JOIA TECH, INC., San Francisco, CA (US)

(72) Inventors: Teresa Watts, San Francisco, CA (US); Lee Mosbacker, San Francisco, CA (US)

(21) Appl. No.: 15/462,158

(22) Filed: Mar. 17, 2017

Related U.S. Application Data
(60) Provisional application No. 62/311,532, filed on Mar. 22, 2016.

(51) Int. Cl. A44C 5/00; H04W 4/00; G08B 25/01; A44C 25/00; A44C 1/00; A44C 7/00; A44C 15/00; H04W 4/02; G06F 1/16

(52) U.S. Cl. CPC A44C 5/0015; H04W 4/02; H04W 4/008; G08B 25/016; G06F 1/163; G06F 1/1686; G06F 1/1698; G06F 1/1605; A44C 1/00; A44C 7/00; A44C 15/0015; A44C 15/005; A44C 25/001; A44C 25/007; G06F 1/1654; G06F 1/3206

(57) ABSTRACT

Some embodiments of the present technology include a system for wearable technology with creative expression including a personalized electronic jewelry device, the personalized electronic jewelry device being configured to receive a personalized input. In some embodiments the system includes a digital display, the digital display being seamlessly housed in the personalized electronic jewelry device. In various embodiments the digital display is coupled with the personalized electronic jewelry device and is configured to display the personalized input.

### CROSS REFERENCE TO RELATED APPLICATION

This Non-Provisional Patent Application claims priority to U.S. Provisional Patent Application No. 62/311,532, filed Mar. 22, 2016, entitled “Systems and Methods for Wearable Technology with Creative Expression”. The aforementioned disclosure is hereby incorporated by reference herein in its entirety including all references and appendices cited therein.

### FIELD OF INVENTION

The present invention pertains to wearable technology. In particular, but not by way of limitation, the present technology provides systems and methods for wearable technology with creative expression.

### SUMMARY

Some embodiments of the present technology include a system for wearable technology with creative expression, including: a personalized electronic jewelry device, the personalized electronic jewelry device configured to receive a personalized input; and a digital display, the digital display being seamlessly housed in the personalized electronic jewelry device, the digital display being coupled with the personalized electronic jewelry device and being configured to display the personalized input.

Various embodiments of the present technology include a system for wearable technology with creative expression, including: a personalized electronic jewelry device, the personalized electronic jewelry device being configured to receive a personalized input; a digital display, the digital display being seamlessly housed in the personalized electronic jewelry device, the digital display being coupled with the personalized electronic jewelry device and being configured to display the personalized input. In some embodiments, the digital display is a digital cabochon, the digital cabochon having a convex obverse digital display and a flat reverse. In various embodiments the system includes a thin flexible battery, the thin flexible battery fitting seamlessly inside of the personalized electronic jewelry device; and a digital camera housed in the personalized electronic jewelry device. In various embodiments, the digital display displays images captured by the digital camera.

Some embodiments of the system for wearable technology with creative expression include a personalized electronic jewelry device, the personalized electronic jewelry device being configured to receive a personalized input and a digital display, the digital display being seamlessly housed in the personalized electronic jewelry device, the digital display also being coupled with the personalized electronic jewelry device and being configured to display the personalized input. In various embodiments, the digital display is a digital cabochon, the digital cabochon having a convex obverse digital display and a flat reverse. In some embodiments, the system includes a thin flexible battery, the thin flexible battery fitting seamlessly inside of the personalized electronic jewelry device. In some embodiments, the system includes a digital camera housed in the personalized electronic jewelry device, and the digital display displays images captured by the digital camera. In various embodiments, the personalized electronic jewelry device and the digital display have modular fitting capabilities, the modular fitting capabilities allowing the personalized electronic jewelry device and the digital display to modularly fit into different personalized electronic jewelry devices.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that can be used to practice aspects of the present technology.

FIG. 2 is simplified diagrams of devices according to exemplary embodiments of the present technology.

FIG. 3 is simplified diagrams of devices according to exemplary embodiments of the present technology.

FIG. 4 is a simplified diagram of a device according to exemplary embodiments of the present technology.

FIG. 5 is a simplified diagram of a device according to exemplary embodiments of the present technology.

FIG. 6 is a simplified diagram of a device according to exemplary embodiments of the present technology.

FIG. 7 is a simplified diagram of a device according to exemplary embodiments of the present technology.

FIG. 8 is a simplified diagram of a device according to exemplary embodiments of the present technology.

FIG. 9 illustrates a computer system according to exemplary embodiments of the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

In some embodiments, system for wearable technology with creative expression, includes a personalized electronic jewelry device, the personalized electronic jewelry device being configured to receive a personalized input; and a digital display, the digital display being seamlessly housed in the personalized electronic jewelry device, the digital display being coupled with the personalized electronic jewelry device and being configured to display the personalized input.

Embodiments of the present technology include wearable technology with creative expression. Various embodiments include technology enhanced jewelry and technology empowered jewelry. For example, personalized images are personalized input, which are displayed on jewelry including necklaces, rings, bracelets, wristbands, pins, pendants, and the like.

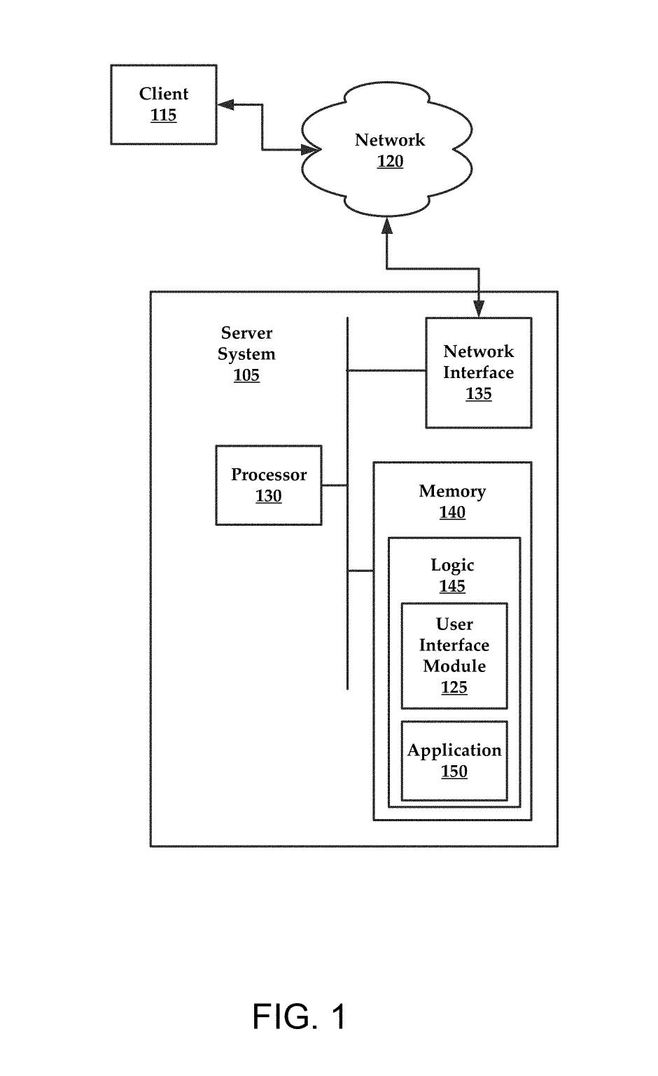

In various embodiments, the present technology allows a user to change the look of their jewelry with an application on their mobile device (e.g. smart phone, tablet etc.) by displaying fonts, photos, graphics, videos, and the like. In some embodiments, the personalized input is a digital image, video, graphic, font, message, animation, slideshow, hologram, and holograph. For example, a user may input images in various formats (e.g. JPEG, GIF, PNG) and short video clips via Bluetooth to personalize their jewelry. Exemplary system architecture is displayed in FIG. 1 for performing this functionality. For example, a user may upload their favorite photo(s), graphic(s), and/or message(s) to jewelry using an application on their mobile device. Thus, a user may connect fashion and technology.

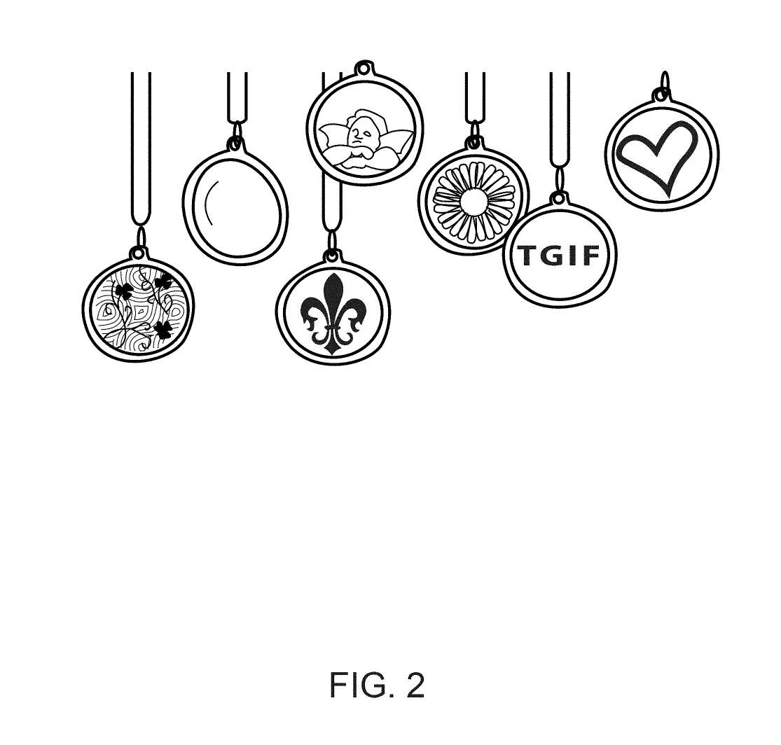

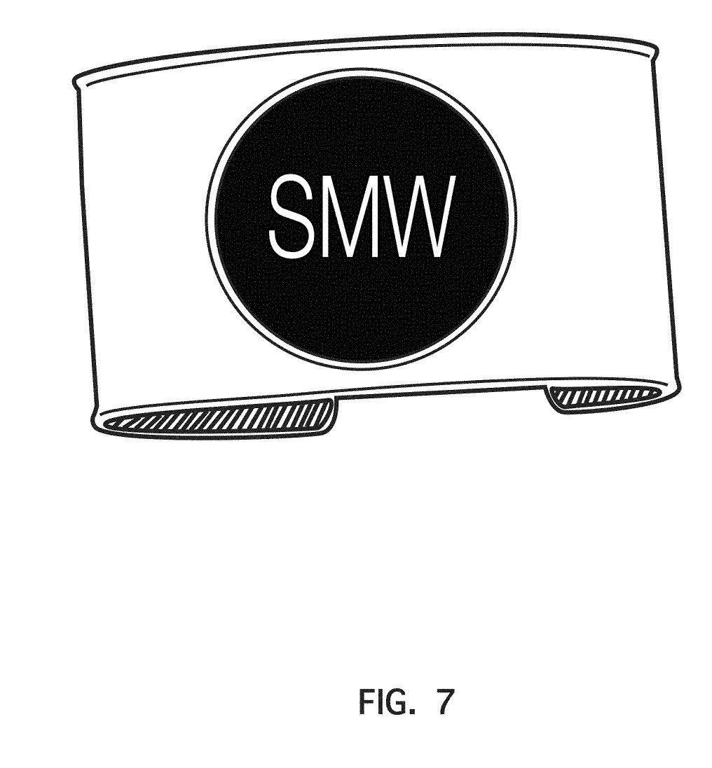

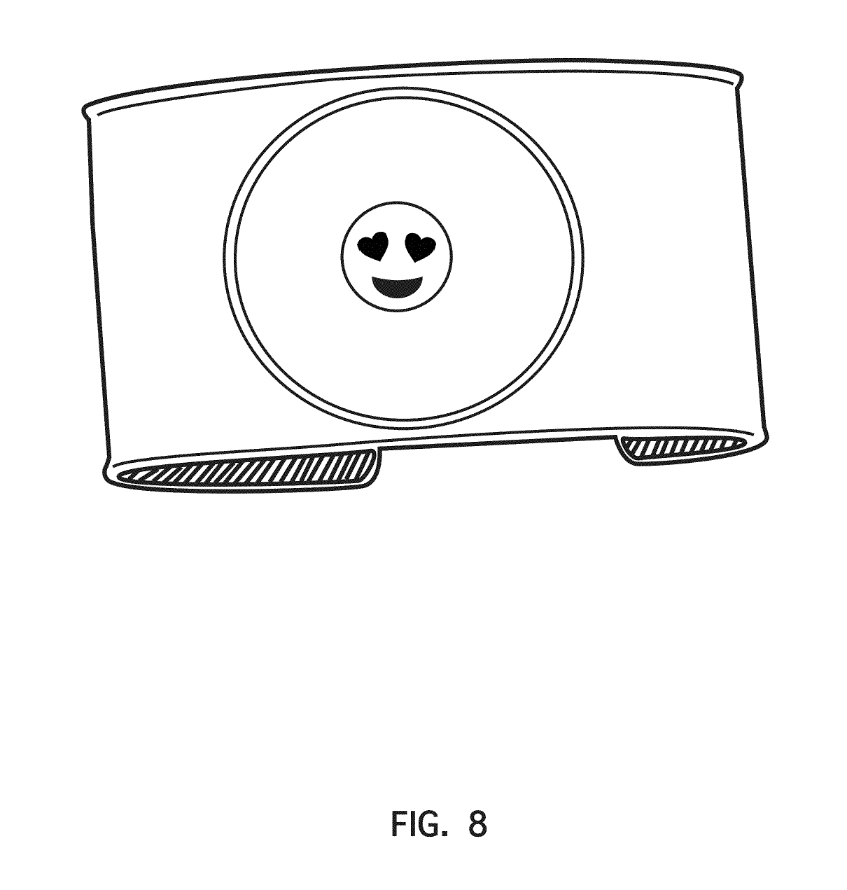

In some embodiments of the present technology, jewelry is charms of smaller sizes and various shapes including pendants, bracelets, dangling earrings, money clips, key fobs, purse charms, carabiners, and the like. In some embodiments, the personalized electronic jewelry device is a locket, bracelet, pendant, necklace, watch, earring, brooch, charm, key fob, or purse ornament. For example, FIGS. 2-8 display devices according to embodiments of the present technology. In various embodiments, a user shares their visual inspirations with people around them by displaying their personalized input such as selected images on personalized electronic jewelry. For example, a user may upload their own images and/or select images from a gallery of work from a curated selection of artists, photographers, and designers. In some embodiments, a digital camera housed in the personalized electronic jewelry device and the digital display automatically displays images captured by the digital camera. In some embodiments, the personalized input further comprises sound. Thus, a user is enabled to channel their inner artist by displaying creative expression on wearable technology.

In various embodiments of the present technology, the digital display is seamlessly housed in the personalized electronic jewelry device. For example, the diameter of the display on the jewelry is the same diameter as the finished piece of jewelry for seamless elegance. Additionally, the display on the jewelry is thin to minimize interference with the “natural” look of the jewelry.

In some embodiments of the present technology, the personalized electronic jewelry device and the digital display have modular fitting capabilities allowing the personalized electronic jewelry device and the digital display to modularly fit into different personalized electronic jewelry devices. For example, the digital display can be removed form one jewelry device and placed into another jewelry device.

In various embodiments of the present technology, the digital display is a digital cabochon. In some instances, a digital cabochon has a convex (rounded) obverse display and a flat reverse display. In various instances, the digital cabochon is an elliptical shape.

In some embodiments, the electronic jewelry includes a thin flexible battery, which fits seamlessly inside of the personalized electronic jewelry device. In various embodiments, the electronic jewelry includes a rechargeable battery to be able to continuously display an image for at least eight hours. The electronic jewelry includes a light sensor to detect when the display is in total darkness to signal the display to initiate “sleep” mode to conserve battery life. In some embodiments, the electronic jewelry digital display automatically turns on a low power mode in a low light environment to conserve power. The low power mode maintains a minimal threshold of power to make display of the personalized input visible to a user in the low light environment on the digital display. Embodiments of the electronic jewelry are enabled with wireless charging. Embodiments also include wired changing through a minimal wired connection (e.g. micro USB, mini USB, etc.) and/or dock charging. For example, a dock charger may in the form of a jewelry box to allow for simultaneous charging and storage.

Various embodiments of the electronic jewelry include a Global Positioning System (GPS) to allow for a “find my locket” feature. Thus, a user may locate their electronic jewelry by activating the GPS features. In some embodiments, a GPS module tracks a geographic position of a second personalized electronic jewelry device and a digital display displays the geographic position of the second personalized electronic jewelry device. For example, a mother with a personalized jewelry device can track the location of her child with the second personalized jewelry device.

In some embodiments, the electronic jewelry wirelessly communicates with other systems. For example, the electronic jewelry communicates with other systems using Bluetooth and near-field communication. In various embodiments, the electronic jewelry includes an “emergency” feature with a personal security enhancement to allow a user to call emergency services when necessary. For example, a user with the “emergency” feature can squeeze their electronic jewelry to connect to 911 or call Life Alert. In various embodiments, the other systems include other personalized electronic jewelry device(s). In some embodiments, the electronic jewelry devices connect in different access modes including a first mode for contacts that are friends only and a second mode for contacts that are related to business only.

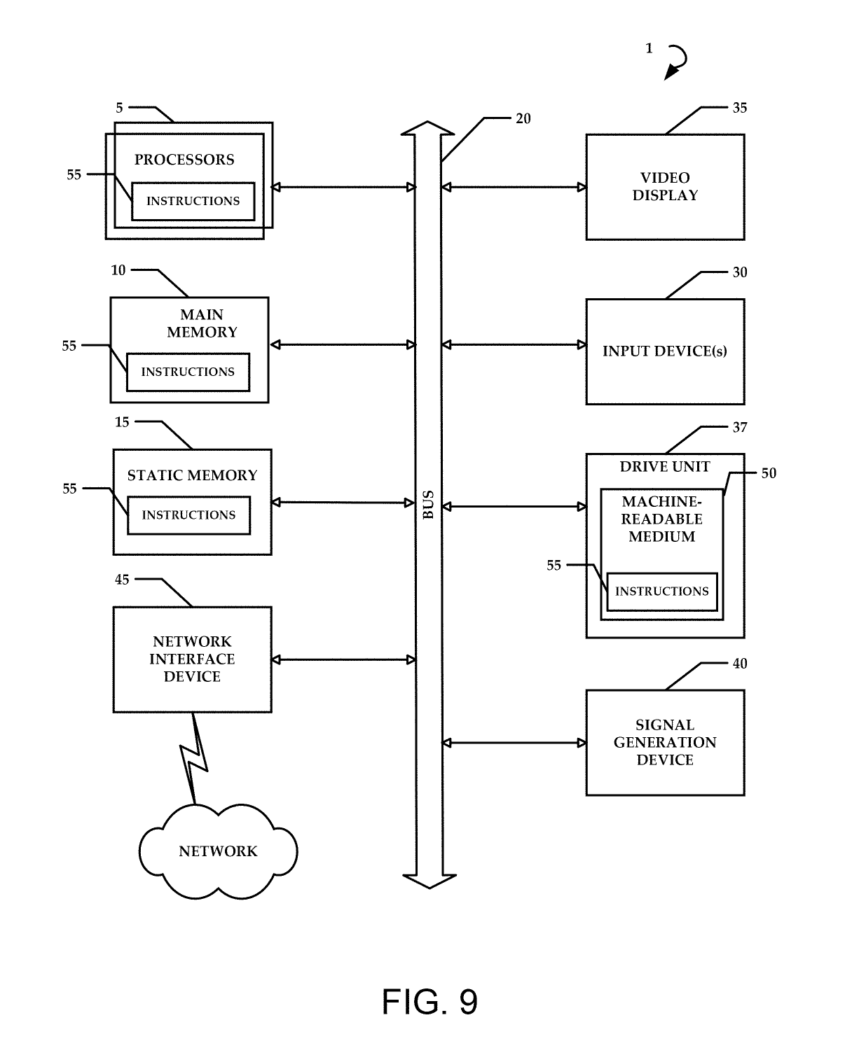

FIG. 1 illustrates an exemplary architecture for practicing aspects of the present technology. The architecture comprises a server system, hereinafter “system 105” that is configured to provide various functionalities, which are described in greater detail throughout this document. Generally the system 105 is configured to communicate with client devices, such as client 115. The client 115 may include, for example, an electronic personalized jewelry device, or other similar computing device. An example of a computing device that can be utilized in accordance with the present technology is described in greater detail with respect to FIG. 9.

The system 105 may communicatively couple with the client 115 via a public or private network, such as network 120. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 105 generally comprises a processor, 130, a network interface 135, and a memory 140. According to some embodiments, the memory 140 comprises logic (e.g., instructions) 145 that can be executed by the processor 130 to perform various methods. For example, the logic may include a user interface module 125 as well as a data aggregation and correlation application (hereinafter application 150) that is configured to provide the functionalities described in greater detail herein.

It will be understood that the functionalities described herein, which are attributed to the system 105 and application 150 may also be executed within the client 115. That is, the client 115 may be programmed to execute the functionalities described herein. In other instances, the system 105 and client 115 may cooperate to provide the functionalities described herein, such that the client 115 is provided with a client-side application that interacts with the system 105 such that the system 105 and client 115 operate in a client/server relationship. Complex computational features may be executed by the server 105, while simple operations that require fewer computational resources may be executed by the client 115, such as data gathering and data display.

In general, the user interface module 125 may be executed by the system 105 to provide various graphical user interfaces (GUIs) that allow users to interact with the system 105. In some instances, GUIs are generated by execution of the application 150 itself. Users may interact with the system 105 using, for example, a client 115. The system 105 may generate web-based interfaces for the client.

In various embodiments the present technology encompasses personalized electronic jewelry. The personalized electronic jewelry (e.g. client 115) provides a plurality of GUIs that allow a user to interact with, and use features of the personalized electronic jewelry including creative expression for wearable technology. For example, a display capsule may be called “Touchstone” and have the functionality of a clickable screen. For instance, one click moves to the next photo in the gallery, two clicks returns to previous image, and a clockwise circle replays a video. In various instances, a user scrolls through saved images by tapping the display, and a user selects images for saving by double tapping the desired image.

FIG. 2 is simplified diagrams of pendants with various personalized images according to exemplary embodiments of the present technology. In various embodiments a user can reference the classic look of a pendant and upload their favorite photo to the pendant. Exemplary personalized images include a flower, heart, and an angel.

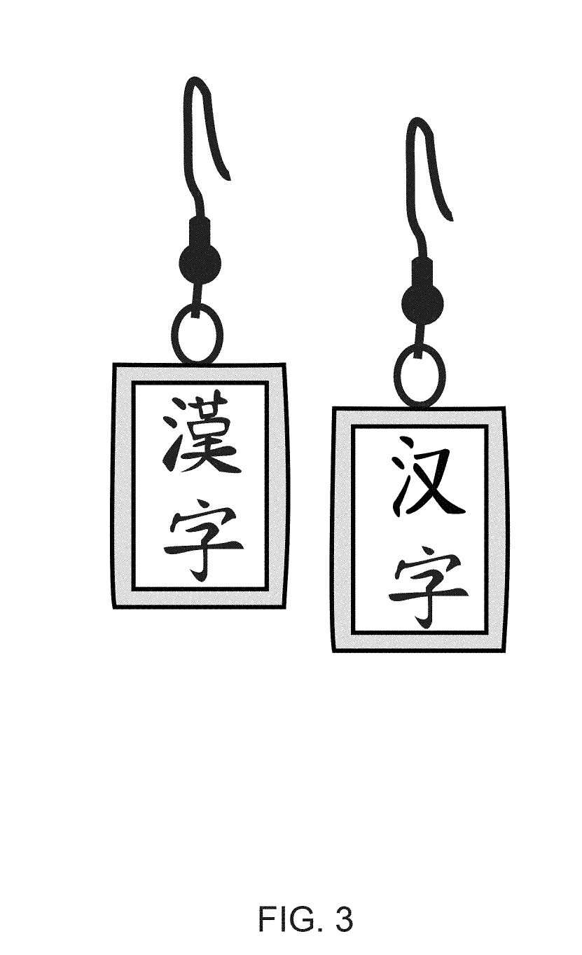

FIG. 3 is simplified diagrams of dangling earrings with personalized graphics according to exemplary embodiments of the present technology. The dangling earnings with personalized images allow a user to share their visual inspiration with people around them. Exemplary images include foreign characters.

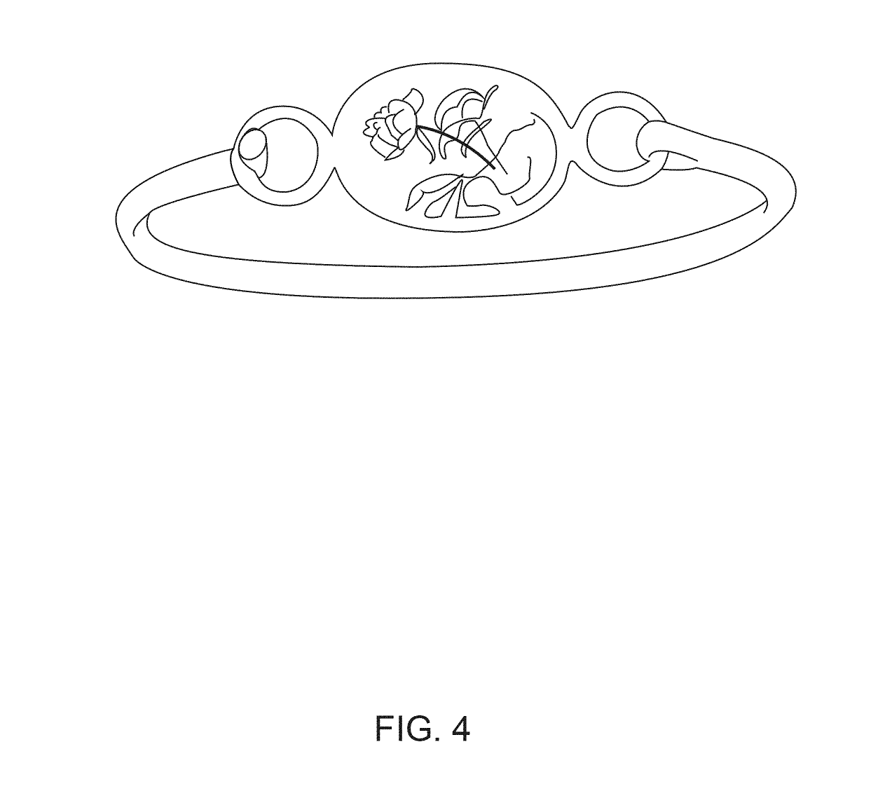

FIG. 4 is a simplified diagram of a bracelet according to exemplary embodiments of the present technology. An exemplary image is a flower.

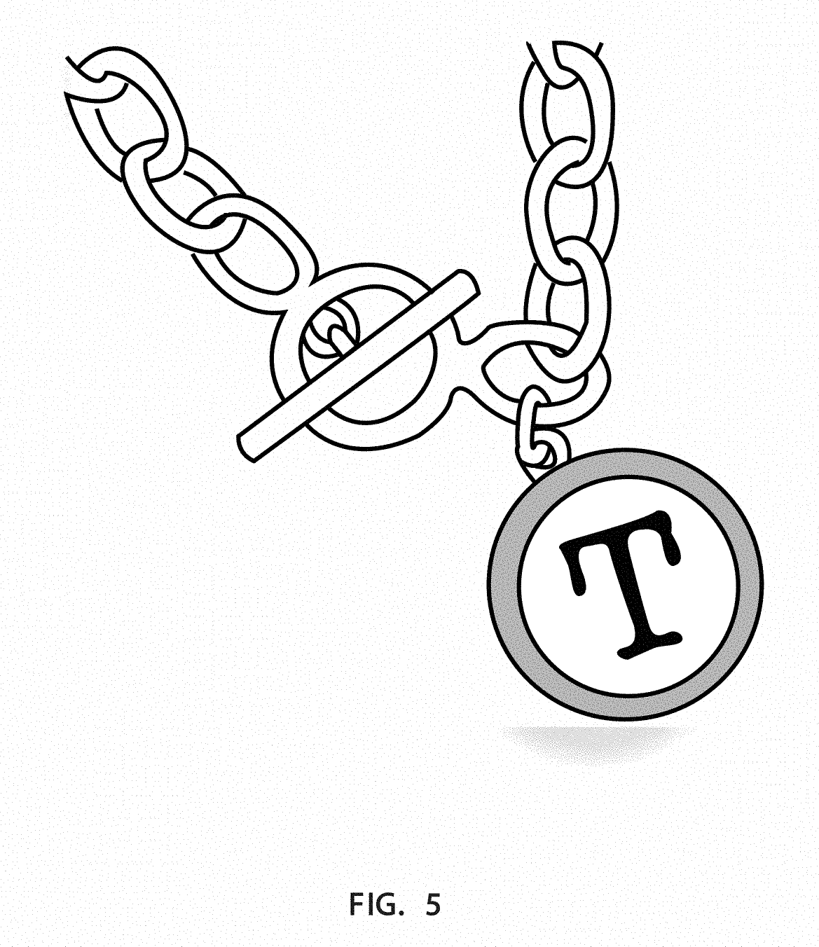

FIG. 5 is a simplified diagram of a charm according to exemplary embodiments of the present technology. A user can display their personalized image on a reversible display on the charm. An exemplary image is a single letter initial.

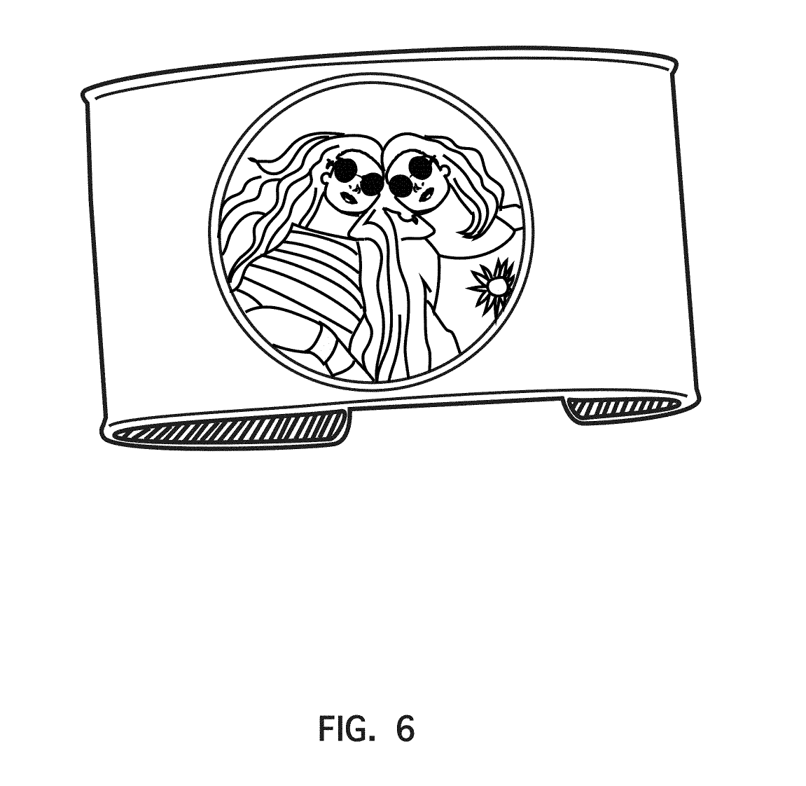

FIGS. 6, 7, and 8 are simplified diagrams of cuffs according to exemplary embodiments of the present technology. Exemplary images on personalized cuffs are friends, three letter initials, and an emoji. In some instances, a user “taps” or touches their cuff with the cuff of a friend, which enables the user and the friend to exchange data including a photo, contact information, and other pertinent information. For example, the use of a personalized image on a display of electronic jewelry can add style with fonts, photos, and/or graphics.

FIG. 9 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120, see FIG. 1) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system for wearable technology with creative expression, comprising:
a personalized electronic jewelry device, the personalized electronic jewelry device being configured to receive a personalized input; and
a digital display, the digital display being seamlessly housed in the personalized electronic jewelry device, the digital display being coupled with the personalized electronic jewelry device and being configured to display the personalized input.

2. The system for wearable technology with creative expression according to claim 1, wherein the digital display is a digital cabochon, the digital cabochon having a convex obverse digital display and a flat reverse.

3. The system for wearable technology with creative expression according to claim 1, further comprising a thin flexible battery, the thin flexible battery fitting seamlessly inside of the personalized electronic jewelry device.

4. The system for wearable technology with creative expression according to claim 1, wherein the system for wearable technology with creative expression is enabled for wireless charging.

5. The system for wearable technology with creative expression according to claim 1, wherein the personalized electronic jewelry device is at least one of a locket, bracelet, pendant, necklace, watch, earring, brooch, charm, key fob, and purse ornament.

6. The system for wearable technology with creative expression according to claim 1, wherein the personalized input is at least one of a digital image, video, graphic, font, message, animation, slideshow, hologram, and holograph.

7. The system for wearable technology with creative expression according to claim 1, wherein the digital display is in low power mode in a low light environment, the low power mode maintaining a minimal threshold to make display of the personalized input visible to a user in the low light environment.

8. The system for wearable technology with creative expression according to claim 1, further comprising a digital camera housed in the personalized electronic jewelry device,
wherein the digital display displays images captured by the digital camera.

9. The system for wearable technology with creative expression according to claim 1, wherein the personalized input further comprises sound.

10. The system for wearable technology with creative expression according to claim 1, further comprising a Global Positioning System (GPS) module.

11. The system for wearable technology with creative expression according to claim 10, wherein the Global Positioning System (GPS) module tracks a geographic position of another personalized electronic jewelry device; and
wherein the digital display displays the geographic position of the another personalized electronic jewelry device.

12. The system for wearable technology with creative expression according to claim 1, wherein the system for wearable technology with creative expression wirelessly communicates with other systems by at least one of Bluetooth and near-field communication.

13. The system for wearable technology with creative expression according to claim 12, wherein the other systems are at least one of Life Alert and 911 services.

14. The system for wearable technology with creative expression according to claim 12, wherein the other systems are one or more other personalized electronic jewelry devices, the other personalized electronic jewelry devices communicating with the system for wearable technology with creative expression in different access modes, the different access modes including at least one of a first mode for contacts that are friends only and a second mode for contacts that are related to business only.

15. The system for wearable technology with creative expression according to claim 1, wherein the personalized electronic jewelry device and the digital display have modular fitting capabilities, the modular fitting capabilities allowing the personalized electronic jewelry device and the digital display to modularly fit into different personalized electronic jewelry devices.

16. A system for wearable technology with creative expression, comprising:
a personalized electronic jewelry device, the personalized electronic jewelry device being configured to receive a personalized input;
a digital display, the digital display being seamlessly housed in the personalized electronic jewelry device, the digital display being coupled with the personalized electronic jewelry device and being configured to display the personalized input;
wherein the digital display is a digital cabochon, the digital cabochon having a convex obverse digital display and a flat reverse;
a thin flexible battery, the thin flexible battery fitting seamlessly inside of the personalized electronic jewelry device; and
a digital camera housed in the personalized electronic jewelry device, wherein the digital display displays images captured by the digital camera.

17. A system for wearable technology with creative expression, comprising:
a personalized electronic jewelry device, the personalized electronic jewelry device being configured to receive a personalized input;
a digital display, the digital display being seamlessly housed in the personalized electronic jewelry device, the digital display being coupled with the personalized electronic jewelry device and being configured to display the personalized input;
wherein the digital display is a digital cabochon, the digital cabochon having a convex obverse digital display and a flat reverse;
a thin flexible battery, the thin flexible battery fitting seamlessly inside of the personalized electronic jewelry device; and
a digital camera housed in the personalized electronic jewelry device,
wherein the digital display displays images captured by the digital camera;
wherein the personalized electronic jewelry device and the digital display have modular fitting capabilities, the modular fitting capabilities allowing the personalized electronic jewelry device and the digital display to modularly fit into different personalized electronic jewelry devices.

18. The system for wearable technology with creative expression according to claim 17, wherein the digital display is in low power mode in a low light environment, the low power mode maintaining a minimal threshold to make display of the personalized input visible to a user in the low light environment.

19. The system for wearable technology with creative expression according to claim 17, further comprising a Global Positioning System (GPS) module, the Global Positioning System (GPS) module tracking a geographic position of another personalized electronic jewelry device; and
wherein the digital display displays the geographic position of the another personalized electronic jewelry device.

20. The system for wearable technology with creative expression according to claim 17, wherein the system for wearable technology with creative expression wirelessly communicates with other systems by at least one of Bluetooth and near-field communication, the other systems being one or more other personalized electronic jewelry devices, the other personalized electronic jewelry devices communicating with the system for wearable technology with creative expression in different access modes, the different access modes including at least one of a first mode for contacts that are friends only and a second mode for contacts that are related to business only.
